(19) United States
(12) Patent Application Publication
(10) Pub. No.: US 2015/0235276 A1
(43) Pub. Date: Aug. 20, 2015

(54) Method And System Of Distributing, Advertising, And Fundraising

(71) Applicant: Colter McKinley Wilson, Idaho Falls, ID (US)

(72) Inventor: Colter McKinley Wilson, Idaho Falls, ID (US)

(21) Appl. No.: 14/181,344

(22) Filed: Feb. 14, 2014

(51) Int. Cl. G06Q 30/02

(52) U.S. Cl. CPC G06Q 30/0273; G06Q 30/0279

(57) ABSTRACT

This disclosure provides a method and system using an internet-connected computing device to distribute, advertise, promote, sell, and fundraise with advertising budgets allocated in whole or in part to designated third-party beneficiaries in exchange for advertising placement alongside free or fee-based digital or physical content. Content owners may provide multiple forms of advertising for sponsors. Sponsors may purchase or bid against other sponsors for advertising placement to become current or next content sponsor. Content is found by searchable criteria. Download, stream, or purchase of content is available only by sharing specific URL and/or subscribing through social networking, text messaging, emailing, and/or other methods. Content recipients receive free or discounted content while fundraising for beneficiary with sponsor funds. Content recipients may also purchase additional content from and/or donate to the content owner, sponsor, and/or beneficiary. Membership and/or commission fees may apply.

### BACKGROUND OF THE INVENTION

1. Field of the Invention

The present invention is a method and system using a series of steps for distributing content to content recipients by assigning a content sponsor's advertising budget to fund beneficiaries through an online fundraising platform. Content is searchable using an internet-connected computing device. Content download, stream, or purchase is available by sharing the link of a specific URL and/or subscribing to social networking, text messaging, emailing, or other methods. Content sponsors may purchase advertising or bid against other content sponsors for advertising on particular content. Content recipients may purchase additional content or services offered at a fixed or variable price with or without advertising and/or donate to the content owner, content sponsor, and/or beneficiary of sponsor funds. The web platform that implements this method and system may charge a membership fee and/or commission fee to content owners, content sponsors, content recipients, and/or fund beneficiaries.

2. Description of the Prior Art

U.S. Pat. No. 7,769,738 is a method for “processing search requests and for performing searches over a network.” This search engine generates money for charity each time a website visitor uses the search engine to search for anything on the Internet while being exposed to advertising. A website user must register and log into the search engine and then select which charity they wish to support. A certain amount of money is generated each time a user searches the internet, fills out a survey, watches a video ad, clicks a banner ad, and views other forms of advertising though said search engine.

This method of processing search requests over the Internet is not likely to generate a substantial amount of fundraising money for multiple reasons. The new user has the obstacle of initially registering, and repeat users must login into the search engine each time in order to participate. Then, the user is prompted to use the search engine to find surveys to fill out. One survey may take 20 minutes to fill out, yet only generate less than one dollar to the user's charity of choice. Additional advertising through this system such as video ads or banner ads generate a few cents which does not entice the user to waste time by using this search engine. A user has more incentive to spend 20 minutes working a job that will pay more than one dollar for that amount of time and donate that money to charity. A user may prefer another search engine. A user is not likely to frequently or continually use this platform because it is cumbersome, time-consuming, and generates little funds to charity.

U.S. Publication Number US2013/0254011 A1 is a method for “distributing digital content utilizing defined and dynamically displayed start and end dates for a sale, configurable pricing options, the dynamic display of sales data, the option to include a charity of choice and the setting of a sales goal or goals with incentives released or provided to purchasers when the sales goal or goals are achieved”. Here a content owner agrees to waive compensation and sell content with proceeds going to charity. The content recipient buys digital content such as gaming software with the funds going to charity. This concept is widely used offline when a person or business donates a product or service to a community fundraising event allowing the charity to receive the funds from the purchase of donated product or service.

This method of distributing has several disadvantages. The content recipient as a consumer does not receive a tax deduction for their contribution to charity because digital content is received. Thus the content recipient may be less likely to spend a larger amount of money on content associated with the charity. The digital content owner may receive exposure, but not necessarily compensation or tax incentives. Because there is no exclusivity with the platform, the demand for the digital content may be diminished as well as the price content recipient is willing to pay. The content owner is able to sell the same content elsewhere for the same price or less and will be able to achieve financial profit there. Therefore, the content owner will likely promote the sale of such digital content somewhere else where compensation is expected. Additionally, physical content is not distributed with this method. Fundraising sales of content are limited to the time frame between the start and end dates which limits the availability of the content to the content recipient and the ability to continually raise money for a particular charity.

U.S. Publication Number US2007/0198418 A1 is a method of distributing and fundraising where “vouchers or media cards, for redemption of songs, videos, animation, games, and the like may be provided to non-profit organizations or other organizations for subsequent sale to content recipients to raise monies associated with an event or promotion.” This means that a content owner agrees to donate digital content to a non-profit organization, and a content recipient may purchase a voucher or download code from that non-profit organization. After purchasing a download code, the content recipient must go to a specific website in order to enter download code and receive the download already purchased.

This method of distributing and fundraising is not scalable for the non-profit organization because it puts the burden of purchase on the non-profit organization. Content recipients have to go through additional steps to manually enter voucher download code through a separate platform.

Charity Miles, LLC (www.charitymiles.org) is a method of fundraising for charity using a health and fitness application (app) for phones and mobile devices. The app incorporates Global Positioning System (GPS) technology to determine the change in location of the app user. A sponsor donates funds to a charity for every mile that the app user walks, runs, or bikes. The app user selects a charity from a directory of participating charities that will benefit from sponsor's money. When the app user has completed his/her workout the sponsor's logo image or message is promoted. Longer distance traveled equates to a larger amount of money generated to the selected charity.

This method of fundraising is limited to those who are able and choose to walk, run, or bike while outside. This excludes people that do not or cannot exercise, people that use a gym membership to exercise with a treadmill or stationary bike, and people that do not own a mobile device with GPS functionality. The sponsor advertising is not displayed continuously as the app is in use. The charity benefiting is not displayed continuously as the app is in use. Battery life on the mobile device is heavily drained as the app is in use making an app user less likely to use the app when the mobile device battery is not fully charged. The only way that this method of fundraising is possible is by the mobile application platform taking a portion of the money due to charity as an administrative cost. It does not encourage a platform user to become a sponsor. It does not encourage a platform user to donate further to a desired charity.

Pay with a Tweet (www.paywithatweet.com) is a method of distributing digital content allowing a website visitor to receive free digital content by sharing a website link on a preferred social network. A content owner distributes content. Content recipient shares the website link where one may acquire content through a social networking website with no funds exchanged between any parties, and the content recipient then receives the free digital content.

This method of distributing has several problems to address. It is not sustainable for the content owner to give away something for free without receiving compensation. The website platform receives no revenue. The digital content is listed only on third-party websites. There is no store inventory or index directory that a potential content recipient can browse through to see what digital content is available. The potential content recipient may be less likely to download free content because trends are also not displayed to indicate whether content is popular.

### SUMMARY OF THE INVENTION

The present invention uses an Internet-connected computing device to implement a series of steps to distribute content, advertise content sponsor or sponsors, and fundraise for a beneficiary or beneficiaries by using assignable content advertisement funds. It is new and useful for many industries, but it will be most relevant and disruptive for the entertainment industry and specifically the music industry. The present invention is uniquely different from all prior art and will create value for content owners, content sponsors, content recipients, and beneficiaries.

Primary objective is to enable a computer-implemented method of distributing, advertising, and fundraising with a series of steps.

Another Primary objective is to enable a computer-implemented system of distributing, advertising, and fundraising.

Another objective of the present invention is to provide a more effective method of distributing and/or broadcasting content (digital and/or physical) where the initial desired content or service is available to the content recipient without a fee or at a discount because a sponsor agrees to pay for content in whole or in part for the content recipient to be able to receive content with sponsored advertising funds assigned to beneficiary or beneficiaries.

Another objective is to provide a more effective method of advertising to promote products, services, ideas, messages, companies, and charities by placing advertisements on a content owner's distributed content and by prompting or requiring content recipient to share a URL link via a social network, text message, email, or other methods and/or subscribe to social networking, text messaging, emailing, or other methods and then prompting content recipient to purchase additional content or services.

Another objective is to provide a more effective method of fundraising by assigning a sponsor's funds for advertisements placed on content owner's distributed content to a beneficiary or beneficiaries.

It is a further objective that the present invention solves problems from prior art. The problem of a search engine user not being likely to generate a substantial amount of fundraising money to beneficiaries is solved by providing more valuable content, more valuable advertising space, higher-paying sponsors, and more frequent use of the platform. The problem of a content recipient being burdened by the obstacle of registering or logging in to the platform will be solved by not requiring a content recipient to register or log in. The problem of a content recipient wasting time to fill out surveys or be exposed to advertising with minimal money generation will be solved by providing valued content and high paying sponsors. The problem of a user being limited to the use of a specific search engine is not applicable as the content recipient may use any preferred third party search engine to look for content, content owners, sponsors, or beneficiaries. The problem of a content recipient being limited to the use of a required media player is solved by allowing the use of any media player currently installed on a computing device. The problem of a user not frequenting the website platform is solved by providing more valuable content to the content recipient who is then likely to generate a substantial amount of money to beneficiary by obtaining content from different content owners who all support the same beneficiary.

It is a further objective that the present invention solves problems from prior art. The problem of a content recipient not receiving a tax deduction will be solved by a content recipient donating to a beneficiary as an assignable transaction with advertising if beneficiary is a qualifying non-profit organization through a payment platform that sends money directly to the qualifying non-profit organization. This means the content recipient is more likely to donate a larger amount of money to charity. Additionally, the sponsor will also receive a tax deduction for advertising costs. The problem of a content owner not exclusively releasing content through the platform is solved by providing the content owner with compensation for further content, which will increase the content inventory and demand for the content. The demand for the content will also be influenced by the beneficiary associated with such content. The problem of limiting content to digital files will be solved by allowing the ability to distribute physical content in addition to digital content. The problem of content being available for a limited amount of time is solved by creating a fundraising event without an end date that may be canceled as long as there is no current sponsor advertising. The problem of a platform user not being encouraged to donate further to a charity and/or become a sponsor for advertising to additional platform users is solved by the allowing a content recipient to become a sponsor of future content and/or donate further if desired.

It is a further objective that the present invention solves problems from prior art. The problem of a non-profit organization being burdened by managing a digital store or handling the purchase of content by a content recipient will be solved by assigning funds to the beneficiary as a non-profit organization. The problem of content recipients being directed to a separate platform to enter voucher codes in order to complete download will be solved by only having one platform of purchase that accesses content.

It is a further objective that the present invention solves problems from prior art. The problem of limiting fundraising only to users of a mobile device with GPS technology such as a phone will be solved by operating a website platform in addition to a mobile device application. The problem of mobile device battery being drained quickly will be solved by not requiring GPS technology in a mobile application to be turned on in order to fundraise. The problem of not continuously advertising the sponsor or the beneficiary will be solved by continuously advertising the content owner, sponsor, and beneficiary. A content recipient can listen to music or any other media file while at the gym on a stationary bike and have the sponsor advertising continuously displayed visually or broadcast audibly alongside the beneficiary or beneficiaries. The problem of only sustaining the platform through an administrative cost being taken from advertising money that users think is going to the charity is solved by charging content owners, sponsors, and/or beneficiaries a membership fee or commission of products or services sold.

It is a further objective that the present invention solves problems from prior art. The problem of not providing sustainability to the content owner is solved by allowing the content owner to give away a sample product in order to sell and make a profit with further products or services. The problem of the platform not being able to charge commission fees and/or membership fees is solved by allowing content owners, sponsors, and beneficiaries to offer products or services that are not free to a content recipient. The problem of a content recipient not being able to search for content or content owners is solved by listing a store inventory or index directory that any potential content recipient may browse through. The problem of a content recipient not being swayed to download or stream certain content will be solved by displaying trends such as how many other people have downloaded or streamed such content and perhaps ranking content in an index directory of content. The problem of users not sharing a website is be solved by prompting or requiring the content recipient to share such content and/or subscribe for further correspondence through a social network, email, text, or other method.

Any person skilled in the art will be able to visualize and realize these objectives and other objectives relating to the present invention from the accompanying description, drawings, and claims of this patent.

### BRIEF DESCRIPTION OF THE DRAWINGS

FIG. 1 illustrates sequential operation as a flow chart.

FIG. 2 illustrates a platform for a content owner to upload content.

FIG. 3 illustrates a free or discounted content's distribution.

FIG. 4 illustrates the action of sharing a content owner's content.

FIG. 5 illustrates a virtual store facilitating the sale of content.

FIG. 6 illustrates supply and demand with fundraising.

FIG. 7 illustrates website navigation through a directory/index of content, content owners, and beneficiaries.

FIG. 8 illustrates a bidding and buying platform for sponsors.

FIG. 9 illustrates the sponsor uploading media player advertising.

FIG. 10 illustrates advertising placement on a mobile media device.

FIG. 11 illustrates the action of subscribing to a content owner, sponsor, beneficiary, and/or other entities.

FIG. 12 illustrates a content owner or sponsor finding a participating audience.

FIG. 13 illustrates an overview of the process from the perspective of the content recipient.

### DETAILED DESCRIPTION OF THE INVENTION

### 1. Definitions

Content as referred to herein shall represent digital or physical merchandise or service that a consumer will either purchase at a retail or discounted price or receive for free provided there is a content sponsor.

A content owner as referred to herein shall represent an individual and/or entity that owns all rights, titles, and interests including all intellectual property, copyrights, neighboring and allied rights pertaining to any files, products, and/or services.

A sponsor as referred to herein shall represent an individual and/or entity that purchases advertising space on content belonging to content owner.

A content recipient as referred to herein shall represent any individual and/or entity connected to a specific website on the internet that obtains content with or without sponsored advertisements.

A beneficiary as referred to herein shall represent an individual and/or entity either for-profit or not-for-profit that receives all or partial funds from content sponsor pertaining to specific sponsored advertisements.

A product as referred to herein shall represent any content or service provided by the content owner that is only available for purchase by a content recipient as a consumer and has no advertising space available.

A platform as referred to herein shall represent a computer program that has the ability to implement a series of steps through any micro-processor computing device such as a mobile device application or a desktop or laptop personal computer device.

A upload as referred to herein shall represent a digital file that a content owner adds to a specific website's server computer hard drive space to be distributed.

A download as referred to herein shall represent a digital file that a content recipient purchases or receives for free through a specific website to be added to the content recipient's personal computer hard drive space and/or mobile device.

A stream as referred to herein shall represent a digital file or online software that is transmitted by broadcasting content either live or after-the-fact exclusively through an Internet platform or mobile device application.

A venue as referred to herein shall represent a participating individual and/or third-party entity who agrees to provide an audience at a digital website and/or a physical location.

### 2. Best Mode of the Invention

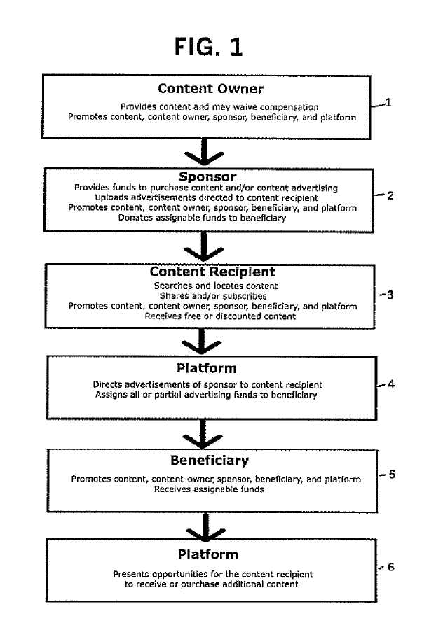

FIG. 1 is a flow-chart demonstrating the best mode contemplated by the inventor to execute a series of steps in a method and system of distributing, advertising, and fundraising. 1 Content owner provides/uploads onto designated website platform content that is a digital product or service and/or a digital representation of a physical product or service. Content owner may waive full or partial compensation for content and/or any royalties. And, content owner promotes content, content owner, sponsor, beneficiary, and platform. 2 Sponsor provides funds to purchase content and/or content advertising, uploads advertisements directed to content recipient, and promotes content, content owner, sponsor, beneficiary, and platform. Sponsor donates assignable funds to beneficiary. 3 Content recipient searches and locates content, shares a URL link and/or subscribes to and promotes content, content owner, sponsor, beneficiary, and/or platform through a social network, email list, text message list, or other methods. Content recipient receives content free or at a discount as a streamable or downloadable digital file, a broadcast radio wave or other wireless transmission, a redeemable credit at any participating entity, or as a physical product or service. 4 Website platform directs advertisements of sponsor to content recipient, and assigns all or partial advertising funds to beneficiary. 5 Beneficiary promotes content, content owner, sponsor, beneficiary, and platform and receives assignable funds. 6 Platform presents content recipient with opportunities to receive or purchase additional content, services, and/or memberships to further promote additional content, content owners, sponsors, beneficiaries, and platform.

The proposed method and system of distributing, advertising, and fundraising will prove to be very useful for the arts by adding value to content and sustainability to content creators and/or owners. It will be very useful for sponsors as a better form of advertising. It will be very useful to content recipients as a better means of receiving content. It will also be very useful to beneficiaries as a better form of fundraising and awareness.

### 3. How to Make the Invention

The web-based platform is made with computer encoding through HTML, Java Script, and additional programming.

The web-based platform enables a content owner to declare legal ownership of content and upload any digital content, digital representation of physical content, and/or services. The types of data a content owner can provide include, but are not limited to: audio data such as MP3, AAC, RIFF, WAV, MIDI; picture data such as JPEG, GIF, PDF, EPS, TIFF; word processing data such as Microsoft Word, Apple Pages, Documents To GO, TextMaker, Google Docs; motion picture data such as MPEG, MOV, AVC, ACI, WMV; and computer aided design (CAD) data such as DWG, DWF, DGN, ACTS, HTML, Adobe files in addition to other software formats and encryption. When transferring data of a very large size File Transfer Protocol (FTP), CODEC (coder/decoder) compression will be applied to minimize strain on the server.

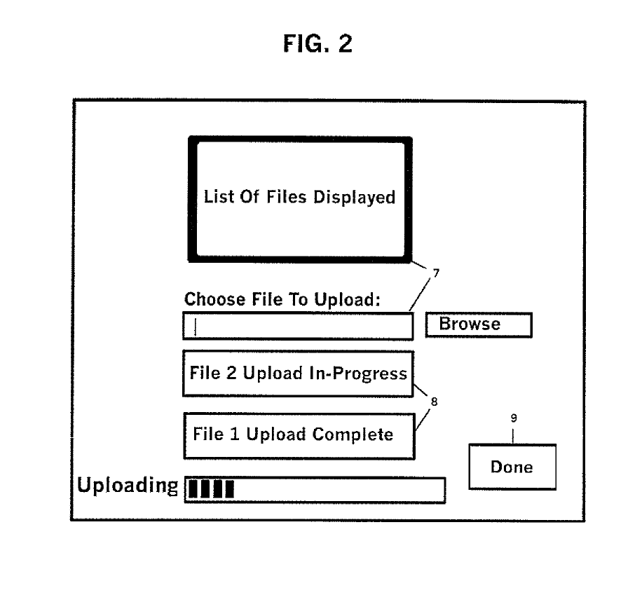

FIG. 2 reveals how website page(s) enables the legal content owner to upload content or services as sponsored content or services available for free or at a discount to content recipients though the web-based platform distribution. A content owner provides digital content or digital representations of physical content by 7 uploading a selected file or 8 multiple files and 9 completing the upload. The web-based platform then enables a content owner to waive payment for the uploaded content and assign any compensation from a sponsor or a content recipient to one or multiple beneficiaries. The website page(s) also prompts the content owner to declare legal ownership of content then enables the content owner to upload digital content, digital representation of physical content, and/or services as non-sponsored content or services available to content recipients to purchase at a fixed or variable price. This means that the content owner can provide a sample content for free or discounted price and after the content recipient receives the content then the content owner offers products for sale.

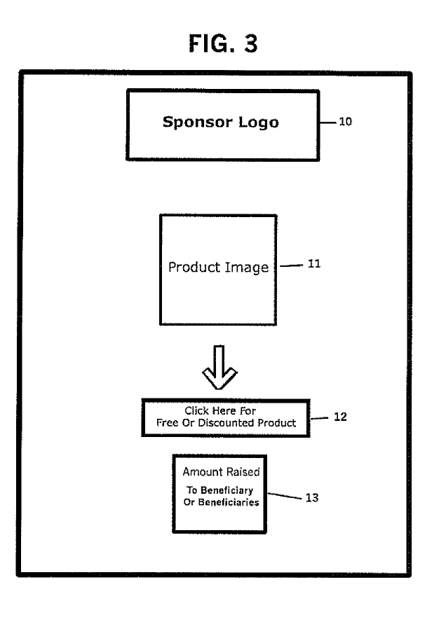

FIG. 3 reveals how website page(s) enables content owners, sponsors, and content recipients to participate in fundraising for a beneficiary or beneficiaries by sponsored advertising funds being assigned to beneficiary or beneficiaries each time a content recipient acquires a sponsored content or service from the content owner. This depicts the distribution of the content owner's uploaded file(s) of digital content or representation of physical content with 10 a sponsor supporting in full or in part the purchase of content delivery to a content recipient with the platform 11 showing the image associated with content, 12 providing a way for the content recipient to stream or download content, and 13 explicating who will benefit from the advertising funds.

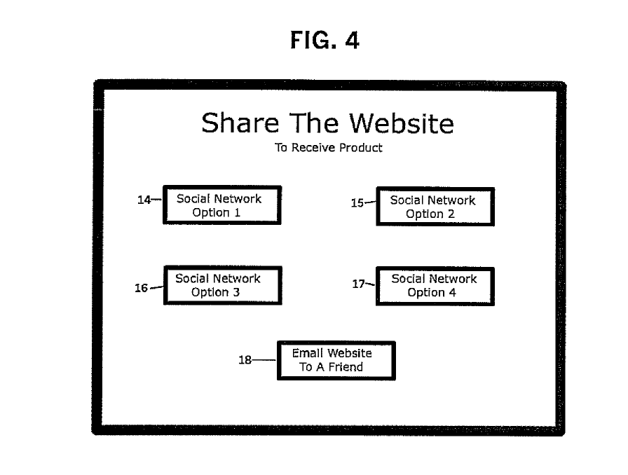

FIG. 4 reveals how the web-based platform prompts or requires content recipient to promote content, content owner, sponsor, beneficiary, web-based platform, and/or other entities by sharing website URL link via social network, SMS/MMS text message, email, video calf, and/or other methods to receive or purchase content. The content recipient may share a website link to promote the content, content owner, sponsor, beneficiary, and platform. The content recipient selects one of these options: 14 share by social networks, 15 share by text message, 16 share by email, 17 share by video call, and 18 share by any other option.

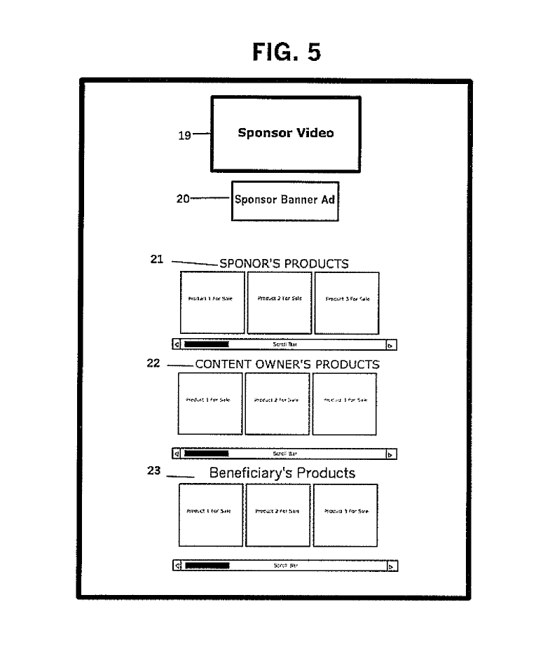

FIG. 5 reveals how website page(s) enables content recipients to purchase non-sponsored content and/or services from a content owner with funds going to the content owner and a commission going to the website platform after content recipient has first acquired the sponsored content. It reveals how to implement additional distribution without sponsor advertisements. The sponsor of content is allowed advertising placement including but not limited to 19 a video ad, 20 a website link redirecting banner ad, and 21 a list of any products for sale. During or after the content recipient plays 19 the sponsor video, the content recipient receives a link to download or stream the digital file or content. The content owner is provided further distribution of 22 additional content (products or services) available for the content recipient to purchase. The beneficiary who receives a percentage of sponsor's advertising funds is also provided the same distribution process to sell 23 content, services, membership, and/or any additional items.

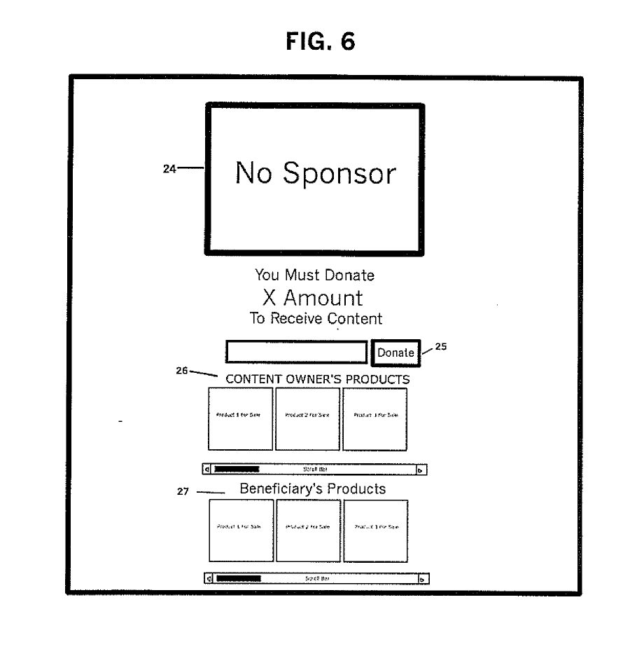

FIG. 6 reveals how to implement distribution of the content that content recipient is to share if and when sponsored advertisement funds for content are depleted or have not begun. When there is 24 no sponsor associated with content, the content recipient becomes the sponsor funding the beneficiary in order to obtain the content by clicking 25 the donate button at the current asking bid or set price of content. Here the content recipient's funds are still assignable to the beneficiary, and the content recipient receives content at a cost without advertising. However, the content recipient is still prompted or required to share the link to acquire content as was described earlier in FIG. 4. In this instance, 26 additional content belonging to the content owner is still made available for sale through this distribution process as well as any content, services, membership, and/or 27 any additional items belonging to the beneficiary.

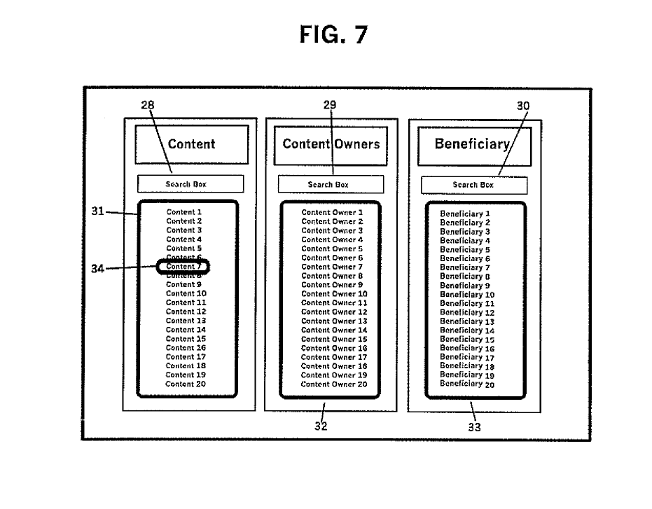

FIG. 7 reveals how the website page(s) enables content recipients to browse an indexed inventory and directory of searchable criteria, trends, ratings, reviews, and rankings of all uploaded content, content owners, sponsors, beneficiaries, and other entities and then select to receive or purchase certain sponsored or non-sponsored content. This allows the ability to navigate through categories including but not limited to: those labeled 28 content, 29 content owners, and 30 beneficiaries by narrowing down search with key words and browsing and displaying 31 a list of content, 32 a list of content owners, and 33 a list of beneficiaries matching criteria. The content recipient may select a specific category and sub category 34 to select a specific content.

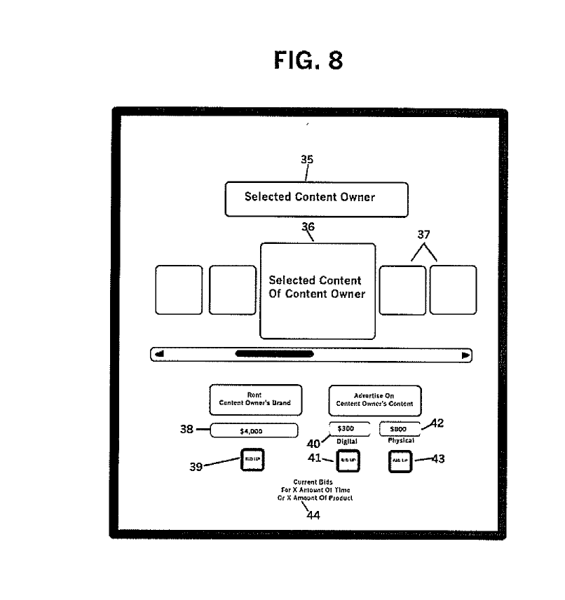

FIG. 8 reveals how the web-based platform enables a sponsor to purchase or bid up the price of renting a content owner's brand, image, or content and/or purchase or bid up the premium the web-based platform charges. After the sponsor has 35 selected content owner and 36 selected specific content from 37 the list of content provided by content owner, the sponsor can purchase multiple forms of advertising and is not limited solely to the types of advertising addressed here. The first form of advertising is by the sponsor renting the content owner's brand for a certain timeframe at 38 a set price or a current bid which the sponsor can 39 bid up or purchase. This allows a sponsor the ability to associate the content owner with the sponsor's brand in some way. The second form of advertising is by enabling the sponsor to 40 advertise on the content owner's digital content and 41 bid up or purchase. The third form of advertising is by 42 the sponsor advertising on the content owner's physical content by 43 biding up or purchasing. There are 44 different timeframes that allow a sponsor to bid or purchase advertising and limits the quantity of the content that will include advertisements.

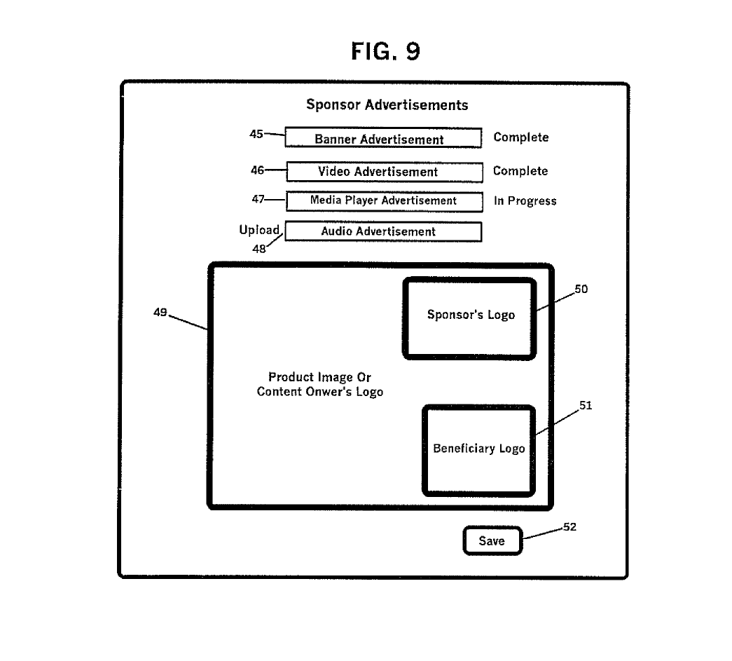

FIG. 9 reveals how the web-based platform enables the sponsor or the content owner to upload digital advertisements such as a banner ad, audio ad, or video ad, and/or physical print advertisements on tangible goods to promote sponsor, content, content owner, beneficiary, web-based platform, and/or other entities. A sponsor does not have to upload all forms of advertising, but is allowed the option of 45 a banner advertisement or coupon that links to a product or service, 46 a video advertisement that communicates the sponsor's brand message that can be included in the download or just streamed one time to access content, 47 a media player advertisement, and 48 an audio advertisement that can be embedded with content owner's audio content. The media player advertisement will be placed on 49 the content owner's product/content image and/or content owner logo with 50 the sponsor's logo or message also being displayed and 51 the beneficiary's logo being placed on the product/content image as well. After the sponsor is finished uploading advertising, 52 the save button will need to be clicked.

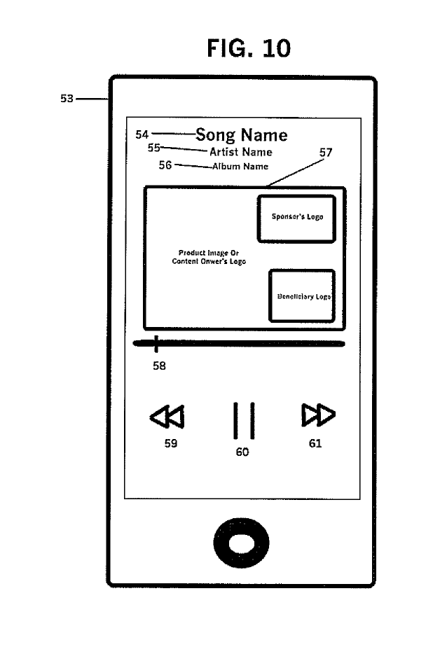

FIG. 10 reveals how the web-based platform enables the distribution of digital files to advertise and fundraise for a content owner, sponsor, beneficiary, web-based platform, and/or other entities each time the files are viewed, streamed, played, or used with software by the content recipient. The sponsor's media player advertisement will be displayed on 53 a mobile device such as a phone. Media software is set up for music as a default, which allows among other things space for meta-data such as 54 song name, 55 artist name, and 56 album name to be included. This is how the device software is able to sort through different content and especially music. 57 The sponsor's uploaded advertisement will be displayed as a picture every time that this particular content is played on a media device. 58 The sponsor's uploaded audio advertisement will be embedded with the content owner's audio content that the content recipient will listen to every time the file is selected and played. The content recipient can 59 rewind/scroll to the left, 60 pause the audio, or 61 fast-forward/scroll to the right.

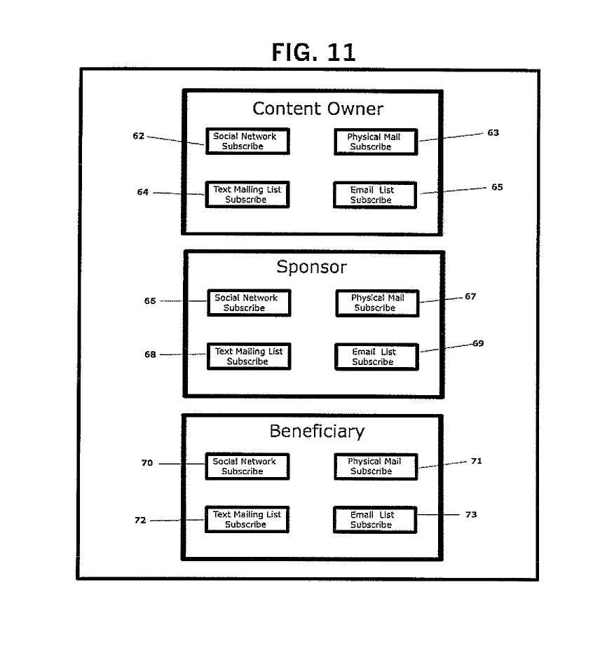

FIG. 11 reveals how the web-based platform prompts or requires a content recipient to subscribe to content owner, sponsor, beneficiary, web-based platform, and/or other entities via social networking, physical mailing, text messaging, emailing, or other methods of contact. The content owner is presented the opportunity to prompt or require the content recipient to subscribe to a form of contact including but not limited to: 62 social network subscribe, 63 physical mail subscribe, 64 text mailing list subscribe, and 65 email list subscribe. The sponsor is presented the opportunity to prompt or require the content recipient to subscribe to a form of contact including but not limited to: 66 social network subscribe, 67 physical mail subscribe, 68 text mailing list subscribe, and 69 email list subscribe. The beneficiary is presented the opportunity to prompt or require the content recipient to subscribe to a form of contact including but not limited to: 70 social network subscribe, 71 physical mail subscribe, 72 text mailing list subscription, and 73 email list subscribe. This subscribe action may be mandatory to receive product just like the share action. The platform and any other entities may be allowed to subscribe in the same manner.

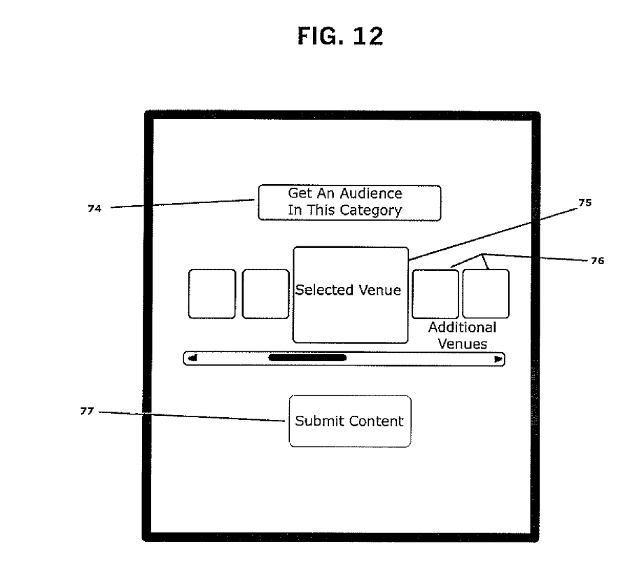

FIG. 12 reveals how to implement a method where a content owner secures a larger audience determined by category of the content owner's content. 74 The selected category allows one to 75 select a venue and 76 browse through additional venues to 77 submit content for consideration.

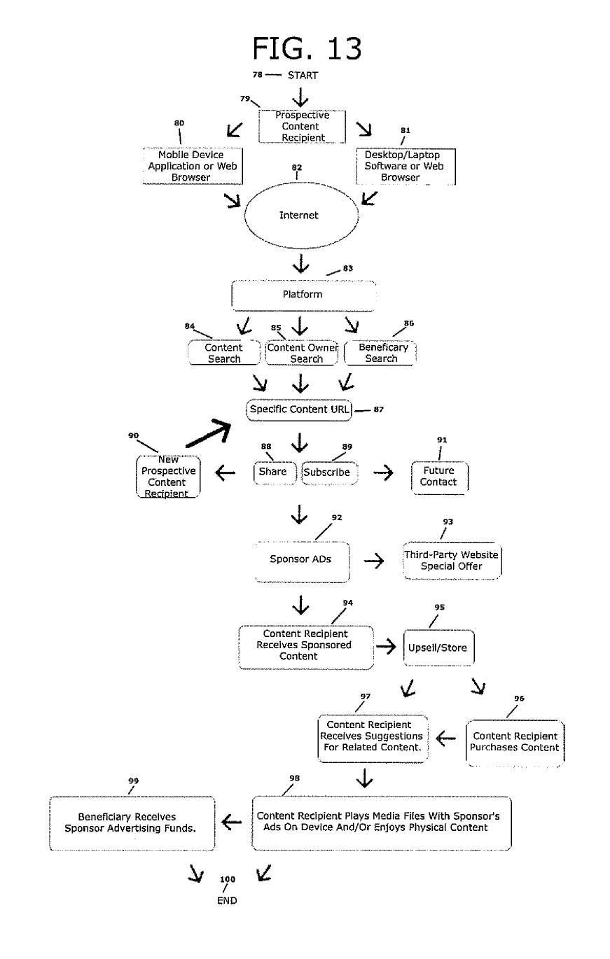

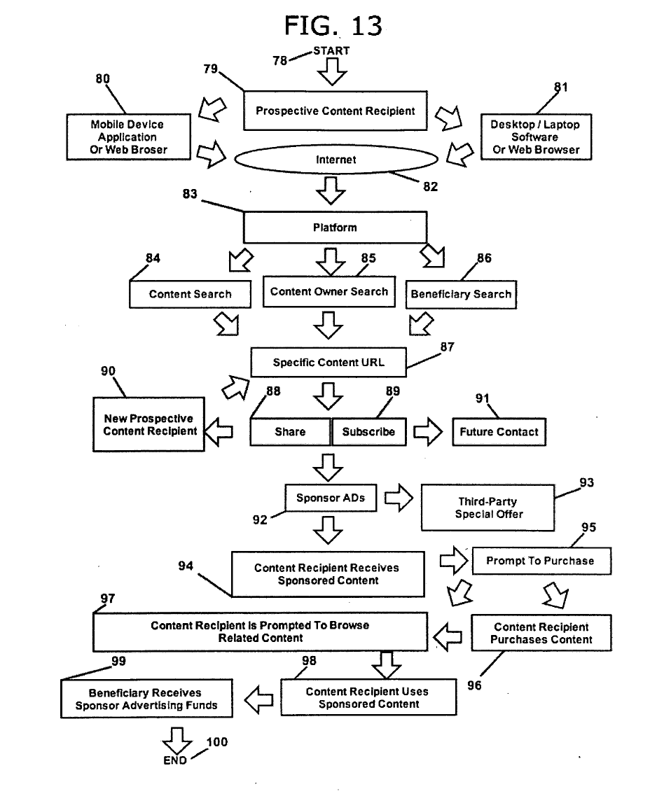

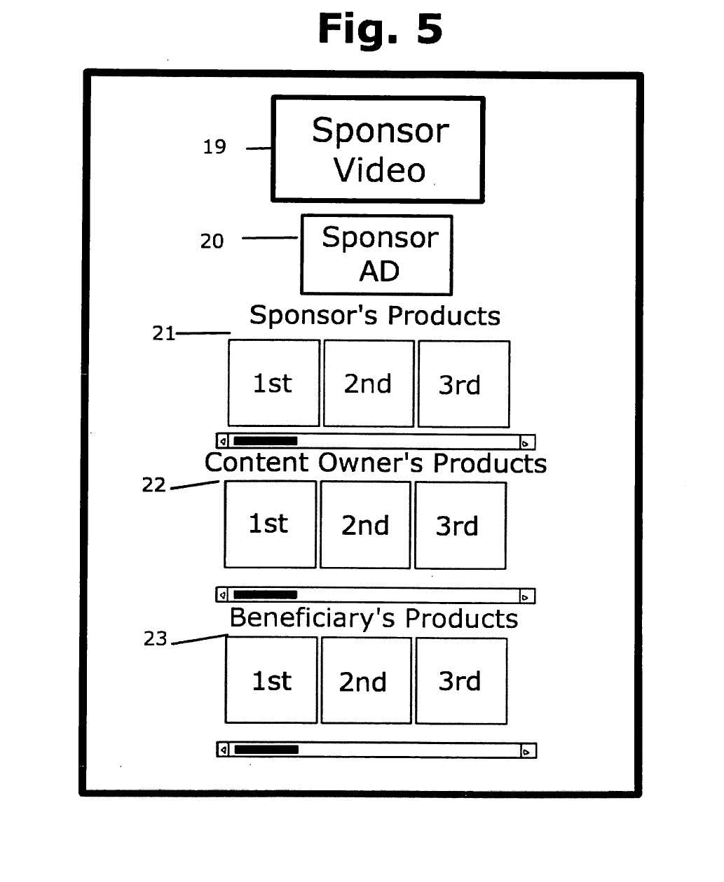

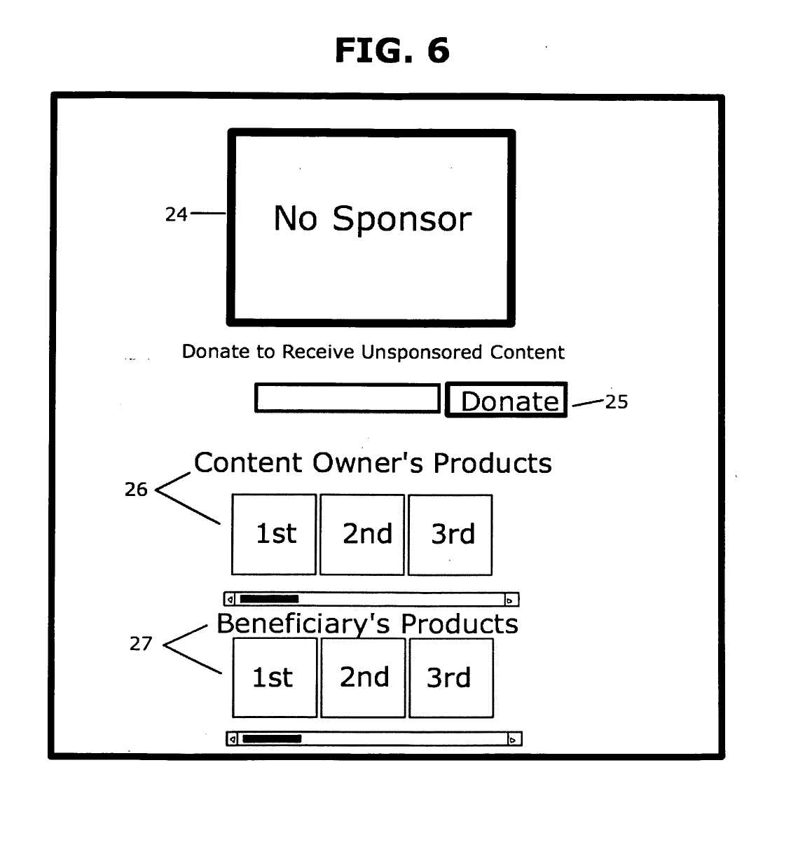

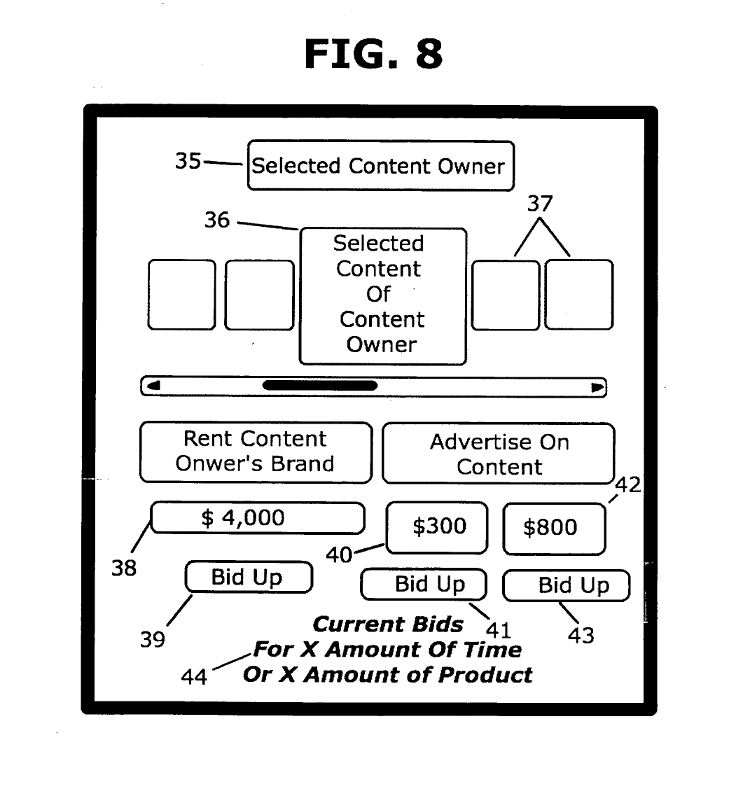

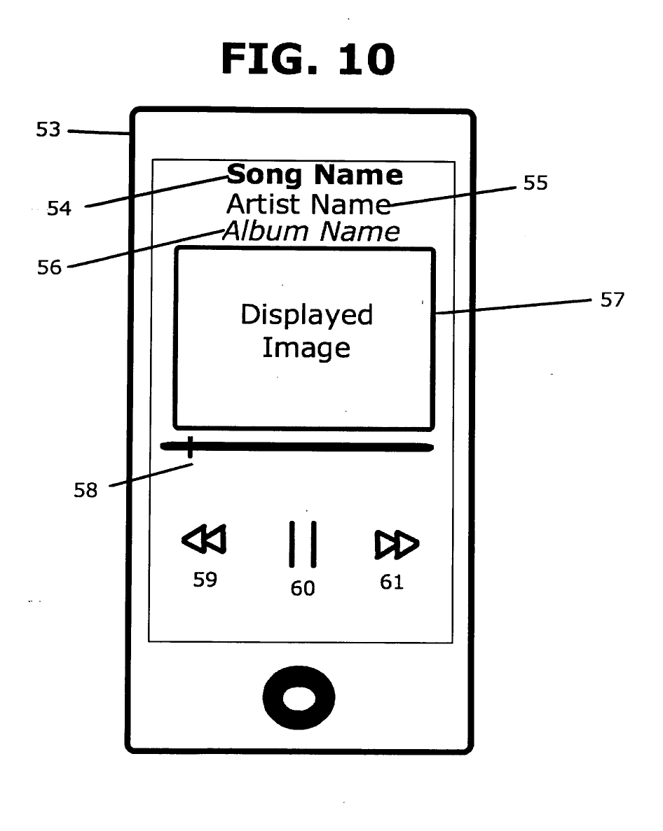

FIG. 13 reveals how to implement a series of steps to conduct the present invention that 78 initiates when an individual wants to obtain content or support a beneficiary becomes 79 a prospective content recipient who uses a computing device such as 80 a mobile application or web browser and/or 81 a desktop or laptop software or web browser that connects to 82 the world wide web (Internet). 79 The prospective content recipient then connects to 83 a specific website platform that has searchable criteria that 84 searches for and list specific content through an index directory, 85 searches for and lists specific content owners, and 86 searches for and lists specific beneficiaries. There may be additional searchable criteria or an index for sponsors and/or any other entities. Once, 79 the prospective content recipient refines and selects content, 87 a specific website URL that pertains to specific content is requested by and displayed with 80/81 the computing device that prompts an action to proceed. 79 The prospective content recipient must 88 share 87 the specific content URL link via a social network, email, text, or other method and/or 89 subscribe to a social network, email list, text list, or other contact method that pertains to a content owner, sponsor, beneficiary, platform, and/or other entities in order to proceed to obtain content. After 79 the prospective content recipient 88 shares 87 the specific content URL link, it is likely that 90 a new prospective content recipient will also wish to obtain the same content by being directed to 87 the same specific content URL link that 79 the original prospective content recipient referred. When 79 the prospective content recipient 89 subscribes to a contact method, 91 future correspondence or promotions from the content owner, sponsor, beneficiary, 83 platform, and/or other entities will take place. 91 Future correspondences may promote or entice 79 the prospective content recipient to return to 83 the platform to engage in a new 84 content search, 85 content owner search, and/or 86 beneficiary search. After 79 the prospective content recipient 88 shares 87 and/or 89 subscribes, 92 sponsor's advertisements are displayed at a unique website URL address where 83 the platform prompts or requires 79 the prospective content to be directed to 93 an outside website with a special offer of the sponsor. During or after 92 the sponsor advertisements are presented, 94 the sponsored content is acquired by a download or other method. Before, during, or after 94 the sponsored content is acquired, 95 additional content, merchandise, or services are displayed and made available for purchase. If 96 additional content is purchased, suggestions for further purchase of related content and/or further promotion of related sponsored content to acquire may be displayed. If no purchase is made from 95 the content available for purchase, then 97 suggestions of related sponsored content may be displayed. Now 98 the content recipient can play media files in a media player while being able to see and/or hear sponsor's advertisements or use the physical content received with sponsor's advertisements placed on the physical content. All these steps allow 99 the money the sponsor paid for advertisements associated with content to be assignable to the beneficiary who receives the funds, and the then process is 100 complete.

### 4. Examples

The present invention is a web-based platform that facilitates business-to-consumer marketing and enables content owner, sponsor, beneficiary, web-based platform, and/or other entities to provide content directly to content recipient as a potential consumer with advertising space purchased by the content owner, sponsor, content recipient, web-based platform, and/or other entities to be featured on content. In this example, a musical performance in a digital format can be 9 uploaded by a musical artist as a content owner. A sponsor then selects the 35 musical artist and the specific 36 song of musical artist. The website page(s) enables a sponsor to bid or purchase advertisements on selected content and to assign the amount paid for advertising on the content to a selected beneficiary or beneficiaries each time a content recipient acquires the distributed sponsored content. The sponsor agrees to pay for 39 the rental of the musical artist's brand to be displayed on products that the sponsor will sell or to commission the musical artist to make a commercial using sponsor's product and/or service. The sponsor also may agree to pay for 41 digital advertising space and/or 42 physical advertising space on actual physical musical album packaging. In this example, the musical artist may prefer to not allow a sponsor to sponsor a certain song and would rather self-sponsor the song benefiting the beneficiary. The song is then 12 downloaded for free by content recipient, and required to be 14 shared by the content recipient who promotes the brand or message of the artist, sponsor, beneficiary, and/or platform in the sharing action. The artist of the song is presented the opportunity to prompt or require the content recipient to subscribe to a form of contact including but not limited to: 62 social network subscribe, 63 physical mail subscribe, 64 text message list subscribe, and 65 email list subscribe. The sponsor of the artist's song is presented the opportunity to prompt or require the content recipient to subscribe to a form of contact including but not limited to: 66 social network subscribe, 67 physical mail subscribe, 68 text message list subscribe, and 69 email list subscribe. The charity is the sole or partial beneficiary of advertising funds from sponsor of the musical artist's song and will be presented the opportunity to prompt or require the content recipient to subscribe to a form of contact including but not limited to: 70 social network subscribe, 71 physical mail subscribe, 72 text message list subscribe, and 73 email list subscribe. The content recipient watches 19 a sponsor video, sees 20 a sponsor banner ad, and has 21-23 a list of purchasable products or services available to purchase. As part of the download the content recipient may receive downloaded advertisements, coupons, or special offers from sponsor. The content recipient is offered merchandise to purchase from 21 the sponsor, and from 22 the owner of the musical performance such as additional song(s), video(s), or physical content like a t-shirt, poster, and more.

The web-based platform enables a content recipient to donate directly to one or multiple beneficiaries after content has been received. With the above example of music, 23 the beneficiary is a charity, and the charity prompts the content recipient for a donation or to become an annual paying member of the organization. If there was 24 no sponsor, the content recipient must 25 donate a certain amount to the beneficiary in order to receive the audio download. The downloaded file has 57 the sponsor's logo placed on the album image and/or 58 embedded audio or video advertisements/coupons that generate assignable funds to the charity as the beneficiary. The artist can submit 77 the song to participating venues like a talk show or a charity's mailing list to promote the fundraising campaign. The content recipient generates revenue to the charity just by participating in the download or stream of the sponsored song. This same concept can be applied to a chapter of an audio book as the audio content with the additional product for sale being additional chapters of the audio book. In both cases the method may be expanded to streaming audio content rather than downloading audio content. These steps may be implemented through 80 an application for a mobile device or 81 a website through other computing device.

The web-based platform enables a content recipient after receiving content to browse related sponsored or non-sponsored content, beneficiaries, and similar content owners prompting an action to receive or purchase such additional content. In the example above of music the platform will offer 21-23 the additional products for sale 21-23 as well as recommend similar sponsored songs that benefit the same beneficiary.

A content recipient may select a TV show 32 that has released web episodes as a download 12 or stream and a content recipient may select a movie 31 as a download or stream generating assignable revenue with different percentages of funds dispersed to different beneficiaries. A movie released through this system is able to submit 77 a film to participating movie theaters to show it.

The web-based platform enables a sponsor to donate directly to one or multiple beneficiaries after advertising funds on content distributed to content recipients reach a fund goal amount needed to accomplish a task or deliver content. Here a content recipient may download a digital prototype of a product 12 such as software or a digital representation of physical content such as physical prototype or blueprint to be released with all advertising funds 13 set aside until a goal is met or a deadline is met. The funds assigned from advertising build up to a certain point and may be used in conjunction with traditional merchandise pre-sale/crowd funding to provide the capital needed to bring a product or idea to market.

If there are multiple sponsors, one sponsor 10 may donate funds to a beneficiary while the other sponsor may donate 11 a product or service to be given to the content recipient after participating in download as a entry to win product or service.

A sponsor may commission an individual or entity most likely with celebrity status to make 19 a video advertisement or 58 audio advertisement or other form of advertisement for the sponsor that promotes the sponsor's brand, message, or service with the celebrity using such product, service, or brand. The celebrity then may 9 upload content as a content owner for this sponsor or may agree to make advertisements for another content owner to support that particular content. This can be applied with a famous musician releasing 12 musical content while 19 promoting sponsor. This can be applied with a major motion picture company commissioning a filmmaker to make a promotional video advertisement 19 such as a movie trailer with all or part of the budget to be donated to a charity or support a cause like disaster relief. This can also apply to one or more sponsors that together purchase 42 winter jackets with advertising space for company or companies and submit to a celebrity 75 to give the jackets to thousands of homeless people while creating media awareness for the company or companies and doing good.

Politicians may use this form of fundraising for a political campaign where a sponsor 10 or multiple sponsors can agree to purchase advertising to be associated with the politician's content 11 such as voting record or political platform message and assign money to 13 the politician's campaign. A politician can also select 36 a content owner's content to purchase advertising on content that includes a political platform or message, which will generate money to a 13 charity selected by that content owner.

A restaurant may self-sponsor 10 and provide 11 coupons for a free meal or discount as the content to be 12 delivered to a content recipient.

The present invention may be used for 11 gaming software for a content recipient to 12 download or stream to any gaming device. Digital data may be sent to content recipient as a 12 MMS text message.

Related or unrelated content may be bundled together as one 11 collective sponsored content.

Companies may provide sample products 12 to potential consumers as that particular company may 10 sponsor their own samples or have another 10 company sponsor the samples to be provided to content recipient.

The web-based platform facilitates business-to-business marketing and enables a content owner to provide digital and/or physical content sold in bulk quantities to a third-party who may give content away for free to content recipient or resell content to content recipient for any price while third-party may add advertising or additional content to content purchased in bulk. Here, the present invention will be of use to network marketing companies or individuals who will be able to purchase 40 digital or 42 physical content in bulk at a wholesale price and sell in individual quantities 12 at a higher price while still being able to include 10 advertising.

The web-based platform enables a beneficiary or multiple beneficiaries as the assignee to include, but not be limited to: a content owner, content owners, charity, charities, web-based platform, and/or other entities that receive in whole or in part on a recurring cycle the advertising funds relating to distributed sponsored content. This means that the 5 fundraising for a beneficiary through 11 content is paid to the beneficiary monthly or quarterly as the funds are raised through 10 advertising.

### 5. How to Use the Invention

A content owner, sponsor, beneficiary, and content recipient will use the present invention to distribute, advertise, and fundraise for ideas, content, services, and entities through a series of computer-implemented steps that promote the progress of science. Content creators and owners will have a way to promote content or services that have validity determined by its degree of social epidemic. Good content or services will be more frequently distributed, advertised, and fundraised because content recipients will not be willing to recommend bad content or services to a network of peers. The content recipients will share and/or subscribe to receive content to fundraise for a beneficiary with a sponsor's funds.

What is claimed is:

1. A computer-implemented method of distributing, advertising, and fundraising comprising the steps of: a web-based platform that enables a content owner to upload content to be distributed; a web-based platform that enables a content owner to waive payment on certain content and assign payment to a beneficiary; a web-based platform that enables a sponsor to purchase and upload advertising; a web-based platform that enables a sponsor, beneficiary, content owner, and content recipient to engage in business-to-consumer marketing through content distribution; a web-based platform that enables a sponsor, beneficiary, content owner, content recipient, and web-based platform to engage in business-to-business marketing through content distribution; a web-based platform that enables a share content action to promote sponsor, beneficiary, content, content owner, web-based platform, and/or other entities; a web-based platform that enables a subscribe action to enable future contact with the content recipient from the sponsor, beneficiary, content owner, web-based platform, and/or other entities; a web-based platform that enables digital files to use a computing device media player to promote sponsor, beneficiary, content, content owner, web-based platform, and/or other entities; a web-based platform that enables a beneficiary or multiple beneficiaries as assignees to receive advertising funds; a web-based platform that enables a sponsor to donate directly to one or multiple beneficiaries on a recurring time cycle for associated advertising costs; a web-based platform that enables a content recipient to donate directly to one or multiple beneficiaries; a web-based platform that enables a content recipient to browse similar content, content owners, beneficiaries, and/or sponsors after receiving content.

2. A computer-implemented method of distributing, advertising, and fundraising according to claim 1, wherein said web-based platform enables a content owner to declare legal ownership of content and upload any digital content, digital representation of physical content, and/or services.

3. A computer-implemented method of distributing, advertising, and fundraising according to claim 1, wherein said web-based platform enables a content owner to waive payment for selected content and assign any compensation from a sponsor or a content recipient to one or multiple beneficiaries.

4. A computer-implemented method of distributing, advertising, and fundraising according to claim 1, wherein said web-based platform enables a sponsor to purchase or bid up the price of renting a content owner's brand, image, or content and/or purchase or bid up the premium the web-based platform charges and enables the sponsor or the content owner to upload digital advertisements such as a banner ad, audio ad, or video ad, and/or physical print advertisements on tangible goods to promote sponsor, content, content owner, beneficiary, web-based platform, and/or other entities.

5. A computer-implemented method of distributing, advertising, and fundraising according to claim 1, wherein said web-based platform facilitates business-to-consumer marketing and enables content owner, sponsor, beneficiary, web-based platform, and/or other entities to provide content directly to content recipient as a potential consumer with advertising space purchased by the content owner, sponsor, content recipient, web-based platform, and/or other entities to be featured on content.

6. A computer-implemented method of distributing, advertising, and fundraising according to claim 1, wherein said web-based platform facilitates business-to-business marketing and enables a content owner to provide digital and/or physical content sold in bulk quantities to a third-party who may give content away for free to content recipient or resell content to content recipient for any price while third-party may add advertising or additional content to content purchased in bulk.

7. A computer-implemented method of distributing, advertising, and fundraising according to claim 1, wherein said web-based platform prompts or requires content recipient to promote content, content owner, sponsor, beneficiary, web-based platform, and/or other entities by sharing website URL link via social network, SMS/MMS text message, email, video call, and/or other methods to receive or purchase content.

8. A computer-implemented method of distributing, advertising, and fundraising according to claim 1, wherein said web-based platform prompts or requires content recipient to subscribe to content owner, sponsor, beneficiary, web-based platform, and/or other entities via social networking, physical mailing, text messaging, emailing, or other methods of contact.

9. A computer-implemented method of distributing, advertising, and fundraising according to claim 1, wherein said web-based platform enables digital files to include but not be limited to: audio/music files, picture files, video files, and any computer-aided design files to promote and fundraise for a content owner, sponsor, beneficiary, web-based platform, and/or other entities each time the files are viewed, streamed, played, or used with software by the content recipient.

10. A computer-implemented method of distributing, advertising, and fundraising according to claim 1, wherein said web-based platform enables a beneficiary or multiple beneficiaries as the assignee to include, but not be limited to: a content owner, content owners, charity, charities, web-based platform, and/or other entities that receive in whole or in part on a recurring cycle the advertising funds relating to distributed sponsored content.

11. A computer-implemented method of distributing, advertising, and fundraising according to claim 1, wherein said web-based platform enables a sponsor to donate directly to one or multiple beneficiaries after advertising funds on content distributed to content recipients reach a fund goal amount needed to accomplish a task or deliver content.

12. A computer-implemented method of distributing, advertising, and fundraising according to claim 1, wherein said web-based platform enables a content recipient to donate directly to one or multiple beneficiaries after content has been received.

13. A computer-implemented method of distributing, advertising, and fundraising according to claim 1, wherein said web-based platform enables a content recipient after receiving content to browse related sponsored or non-sponsored content, beneficiaries, and similar content owners prompting an action to receive or purchase such additional content.

14. A computer-implemented system of distributing, advertising, and fundraising, comprising: website page(s) that enables a content owner to upload sponsored content and/or services; website page(s) that enables a sponsor to bid or purchase advertising space to be featured on content distributed to content recipients with advertising costs being assignable to a selected beneficiary or beneficiaries; website page(s) that enables a content owner to upload non-sponsored content and/or services available for purchase by content recipients; website page(s) that enables content recipients to browse a searchable inventory and directory of content, content owners, sponsors, beneficiaries, and/or other entities; website page(s) that enables content owners, sponsors, and content recipients to participate in fundraising for a beneficiary or beneficiaries through the use of sponsored advertising funds each time a content recipient acquires sponsored content and/or services; website page(s) that enables content recipients to purchase non-sponsored content and/or services from a content owner after content recipient has first acquired the sponsored content.

15. A computer-implemented system of distributing, advertising, and fundraising according to claim 14, wherein said website page(s) enables the legal content owner to upload content or services as sponsored content or services available for free or at a discount to content recipients though the web-based platform distribution.

16. A computer-implemented system of distributing, advertising, and fundraising according to claim 14, wherein said website page(s) enables a sponsor to bid or purchase advertisements on selected content and to assign the amount paid for advertising on the content to a selected beneficiary or beneficiaries each time a content recipient acquires the distributed sponsored content.

17. A computer-implemented system of distributing, advertising, and fundraising according to claim 14, wherein said website page(s) prompts a content owner to declare legal ownership of content then enables the content owner to upload digital content, digital representation of physical content, and/or services as non-sponsored content or services available to content recipients to purchase at a fixed or variable price.

18. A computer-implemented system of distributing, advertising, and fundraising according to claim 14, wherein said website page(s) enables content recipients to browse an indexed inventory and directory of searchable criteria, trends, ratings, reviews, and rankings of all uploaded content, content owners, sponsors, beneficiaries, and other entities and then select to receive or purchase certain sponsored or non-sponsored content.

19. A computer-implemented system of distributing, advertising, and fundraising according to claim 14, wherein said website page(s) enables content owners, sponsors, and content recipients to participate in fundraising for a beneficiary or beneficiaries by sponsored advertising funds being assigned to beneficiary or beneficiaries each time a content recipient acquires a sponsored content or service from the content owner.

20. A computer-implemented system of distributing, advertising, and fundraising according to claim 14, wherein said website page(s) enables content recipients to purchase non-sponsored content and/or services from a content owner with funds going to the content owner and a commission going to the website platform after content recipient has first acquired the sponsored content.
